(19) United States
(12) Patent Application Publication
(10) Pub. No.: US 2007/0291767 A1
(43) Pub. Date: Dec. 20, 2007

(54) Systems and methods for a protocol transformation gateway for quality of service

(75) Inventors: Donald L. Smith, Satellite Beach, FL (US); Anthony P. Galluscio, Indialantic, FL (US); Robert J. Knazik, Cocoa Beach, FL (US)

Correspondence Address: MCANDREWS HELD & MALLOY, LTD, 500 WEST MADISON STREET, SUITE 3400, CHICAGO, IL, 60661, US

(73) Assignee: Harris Corporation

(21) Appl. No.: 11/454,517

(22) Filed: Jun. 16, 2006

(51) Int. Cl. H04L 12/56

(52) U.S. Cl. 370/395.21

(57) ABSTRACT

Embodiments of the present invention provide systems and methods for facilitating communication of data. A method includes providing quality of service in a network including receiving data, prioritizing the data, transforming the data to generate transformed data, and communicating the transformed data. The data is received based at least in part on a first protocol. The data is prioritized to support a quality of service standard. The transformed data is based at least in part on a second protocol. The second protocol is different from the first protocol.

### BACKGROUND OF THE INVENTION

The presently described technology generally relates to communications networks. More particularly, the presently described technology relates to systems and methods for a protocol transformation gateway for Quality of Service.

Communications networks are utilized in a variety of environments. Communications networks typically include two or more nodes connected by one or more links. Generally, a communications network is used to support communication between two or more participant nodes over the links and intermediate nodes in the communications network. There may be many kinds of nodes in the network. For example, a network may include nodes such as clients, servers, workstations, switches, and/or routers. Links may be, for example, modem connections over phone lines, wires, Ethernet links, Asynchronous Transfer Mode (ATM) circuits, satellite links, and/or fiber optic cables.

A communications network may actually be composed of one or more smaller communications networks. For example, the Internet is often described as network of interconnected computer networks. Each network may utilize a different architecture and/or topology. For example, one network may be a switched Ethernet network with a star topology and another network may be a Fiber-Distributed Data Interface (FDDI) ring.

Communications networks may carry a wide variety of data. For example, a network may carry bulk file transfers alongside data for interactive real-time conversations. The data sent on a network is often sent in packets, cells, or frames. Alternatively, data may be sent as a stream. In some instances, a stream or flow of data may actually be a sequence of packets. Networks such as the Internet provide general purpose data paths between a range of nodes and carrying a vast array of data with different requirements.

Communication over a network typically involves multiple levels of communication protocols. A protocol stack, also referred to as a networking stack or protocol suite, refers to a collection of protocols used for communication. Each protocol may be focused on a particular type of capability or form of communication. For example, one protocol may be concerned with the electrical signals needed to communicate with devices connected by a copper wire. Other protocols may address ordering and reliable transmission between two nodes separated by many intermediate nodes, for example.

Protocols in a protocol stack typically exist in a hierarchy. Often, protocols are classified into layers. One reference model for protocol layers is the Open Systems Interconnection (OSI) model. The OSI reference model includes seven layers: a physical layer, data link layer, network layer, transport layer, session layer, presentation layer, and application layer. The physical layer is the “lowest” layer, while the application layer is the “highest” layer. Two well-known transport layer protocols are the Transmission Control Protocol (TCP) and User Datagram Protocol (UDP). A well known network layer protocol is the Internet Protocol (IP).

At the transmitting node, data to be transmitted is passed down the layers of the protocol stack, from highest to lowest. Conversely, at the receiving node, the data is passed up the layers, from lowest to highest. At each layer, the data may be manipulated by the protocol handling communication at that layer. For example, a transport layer protocol may add a header to the data that allows for ordering of packets upon arrival at a destination node. Depending on the application, some layers may not be used, or even present, and data may just be passed through.

One kind of communications network is a tactical data network. A tactical data network may also be referred to as a tactical communications network. A tactical data network may be utilized by units within an organization such as a military (e.g., army, navy, and/or air force). Nodes within a tactical data network may include, for example, individual soldiers, aircraft, command units, satellites, and/or radios. A tactical data network may be used for communicating data such as voice, position telemetry, sensor data, and/or real-time video.

An example of how a tactical data network may be employed is as follows. A logistics convoy may be in-route to provide supplies for a combat unit in the field. Both the convoy and the combat unit may be providing position telemetry to a command post over satellite radio links. An unmanned aerial vehicle (UAV) may be patrolling along the road the convoy is taking and transmitting real-time video data to the command post over a satellite radio link also. At the command post, an analyst may be examining the video data while a controller is tasking the UAV to provide video for a specific section of road. The analyst may then spot an improvised explosive device (IED) that the convoy is approaching and send out an order over a direct radio link to the convoy for it to halt and alerting the convoy to the presence of the IED.

The various networks that may exist within a tactical data network may have many different architectures and characteristics. For example, a network in a command unit may include a gigabit Ethernet local area network (LAN) along with radio links to satellites and field units that operate with much lower throughput and higher latency. Field units may communicate both via satellite and via direct path radio frequency (RF). Data may be sent point-to-point, multicast, or broadcast, depending on the nature of the data and/or the specific physical characteristics of the network. A network may include radios, for example, set up to relay data. In addition, a network may include a high frequency (HF) network which allows long rang communication. A microwave network may also be used, for example. Due to the diversity of the types of links and nodes, among other reasons, tactical networks often have overly complex network addressing schemes and routing tables. In addition, some networks, such as radio-based networks, may operate using bursts. That is, rather than continuously transmitting data, they send periodic bursts of data. This is useful because the radios are broadcasting on a particular channel that must be shared by all participants, and only one radio may transmit at a time.

Tactical data networks are generally bandwidth-constrained. That is, there is typically more data to be communicated than bandwidth available at any given point in time. These constraints may be due to either the demand for bandwidth exceeding the supply, and/or the available communications technology not supplying enough bandwidth to meet the user's needs, for example. For example, between some nodes, bandwidth may be on the order of kilobits/sec. In bandwidth-constrained tactical data networks, less important data can clog the network, preventing more important data from getting through in a timely fashion, or even arriving at a receiving node at all. In addition, portions of the networks may include internal buffering to compensate for unreliable links. This may cause additional delays. Further, when the buffers get full, data may be dropped.

In many instances the bandwidth available to a network cannot be increased. For example, the bandwidth available over a satellite communications link may be fixed and cannot effectively be increased without deploying another satellite. In these situations, bandwidth must be managed rather than simply expanded to handle demand. In large systems, network bandwidth is a critical resource. It is desirable for applications to utilize bandwidth as efficiently as possible. In addition, it is desirable that applications avoid “clogging the pipe,” that is, overwhelming links with data, when bandwidth is limited. When bandwidth allocation changes, applications should preferably react. Bandwidth can change dynamically due to, for example, quality of service, jamming, signal obstruction, priority reallocation, and line-of-sight. Networks can be highly volatile and available bandwidth can change dramatically and without notice.

In addition to bandwidth constraints, tactical data networks may experience high latency. For example, a network involving communication over a satellite link may incur latency on the order of half a second or more. For some communications this may not be a problem, but for others, such as real-time, interactive communication (e.g., voice communications), it is highly desirable to minimize latency as much as possible.

Another characteristic common to many tactical data networks is data loss. Data may be lost due to a variety of reasons. For example, a node with data to send may be damaged or destroyed. As another example, a destination node may temporarily drop off of the network. This may occur because, for example, the node has moved out of range, the communication's link is obstructed, and/or the node is being jammed. Data may be lost because the destination node is not able to receive it and intermediate nodes lack sufficient capacity to buffer the data until the destination node becomes available. Additionally, intermediate nodes may not buffer the data at all, instead leaving it to the sending node to determine if the data ever actually arrived at the destination.

Often, applications in a tactical data network are unaware of and/or do not account for the particular characteristics of the network. For example, an application may simply assume it has as much bandwidth available to it as it needs. As another example, an application may assume that data will not be lost in the network. Applications which do not take into consideration the specific characteristics of the underlying communications network may behave in ways that actually exacerbate problems. For example, an application may continuously send a stream of data that could just as effectively be sent less frequently in larger bundles. The continuous stream may incur much greater overhead in, for example, a broadcast radio network that effectively starves other nodes from communicating, whereas less frequent bursts would allow the shared bandwidth to be used more effectively.

Certain protocols do not work well over tactical data networks. For example, a protocol such as TCP may not function well over a radio-based tactical network because of the high loss rates and latency such a network may encounter. TCP requires several forms of handshaking and acknowledgments to occur in order to send data. High latency and loss may result in TCP hitting time outs and not being able to send much, if any, meaningful data over such a network.

Information communicated with a tactical data network often has various levels of priority with respect to other data in the network. For example, threat warning receivers in an aircraft may have higher priority than position telemetry information for troops on the ground miles away. As another example, orders from headquarters regarding engagement may have higher priority than logistical communications behind friendly lines. The priority level may depend on the particular situation of the sender and/or receiver. For example, position telemetry data may be of much higher priority when a unit is actively engaged in combat as compared to when the unit is merely following a standard patrol route. Similarly, real-time video data from an UAV may have higher priority when it is over the target area as opposed to when it is merely in-route.

There are several approaches to delivering data over a network. One approach, used by many communications networks, is a “best effort” approach. That is, data being communicated will be handled as well as the network can, given other demands, with regard to capacity, latency, reliability, ordering, and errors. Thus, the network provides no guarantees that any given piece of data will reach its destination in a timely manner, or at all. Additionally, no guarantees are made that data will arrive in the order sent or even without transmission errors changing one or more bits in the data.

Another approach is Quality of Service (QoS). QoS refers to one or more capabilities of a network to provide various forms of guarantees with regard to data that is carried. For example, a network supporting QoS may guarantee a certain amount of bandwidth to a data stream. As another example, a network may guarantee that packets between two particular nodes have some maximum latency. Such a guarantee may be useful in the case of a voice communication where the two nodes are two people having a conversation over the network. Delays in data delivery in such a case may result in irritating gaps in communication and/or dead silence, for example.

QoS may be viewed as the capability of a network to provide better service to selected network traffic. The primary goal of QoS is to provide priority including dedicated bandwidth, controlled jitter and latency (required by some real-time and interactive traffic), and improved loss characteristics. Another important goal is making sure that providing priority for one flow does not make other flows fail. That is, guarantees made for subsequent flows must not break the guarantees made to existing flows.

Current approaches to QoS often require every node in a network to support QoS, or, at the very least, for every node in the network involved in a particular communication to support QoS. For example, in current systems, in order to provide a latency guarantee between two nodes, every node carrying the traffic between those two nodes must be aware of and agree to honor, and be capable of honoring, the guarantee.

There are several approaches to providing QoS. One approach is Integrated Services, or “IntServ.” IntServ provides a QoS system wherein every node in the network supports the services and those services are reserved when a connection is set up. IntServ does not scale well because of the large amount of state information that must be maintained at every node and the overhead associated with setting up such connections.

Another approach to providing QoS is Differentiated Services, or “DiffServ.” DiffServ is a class of service model that enhances the best-effort services of a network such as the Internet. DiffServ differentiates traffic by user, service requirements, and other criteria. Then, DiffServ marks packets so that network nodes can provide different levels of service via priority queuing or bandwidth allocation, or by choosing dedicated routes for specific traffic flows. Typically, a node has a variety of queues for each class of service. The node then selects the next packet to send from those queues based on the class categories.

Existing QoS solutions are often network specific and each network type or architecture may require a different QoS configuration. Due to the mechanisms existing QoS solutions utilize, messages that look the same to current QoS systems may actually have different priorities based on message content. However, data consumers may require access to high-priority data without being flooded by lower-priority data. Existing QoS systems cannot provide QoS based on message content at the transport layer.

As mentioned, existing QoS solutions require at least the nodes involved in a particular communication to support QoS. However, the nodes at the “edge” of network may be adapted to provide some improvement in QoS, even if they are incapable of making total guarantees. Nodes are considered to be at the edge of the network if they are the participating nodes in a communication (i.e., the transmitting and/or receiving nodes) and/or if they are located at chokepoints in the network. A chokepoint is a section of the network where all traffic must pass to another portion. For example, a router or gateway from a LAN to a satellite link would be a choke point, since all traffic from the LAN to any nodes not on the LAN must pass through the gateway to the satellite link.

As discussed above, existing applications may not be designed to communicate with a node over a network with particular characteristics, such as a tactical data network. For example, legacy and/or commercial off-the-shelf (COTS) applications may expect to communicate with nodes over high speed, reliable networks using a complex transport layer protocol that provides many services such as TCP. As a result, such applications may exhibit undesirable behavior when communicating with nodes over networks such as tactical data networks. For example, an application communicating with a node over a tactical data network with low bandwidth, high latency, and a high data loss rate may not function correctly, or at all, due to timeouts and missing data that prevent a protocol such as TCP from operating properly. Therefore, it is highly desirable to be able to transparently allow an application to communicate with one or more nodes over a tactical data network with QoS without requiring modification of the application.

Thus, there is a need for systems and methods providing QoS in a tactical data network. There is a need for systems and methods for providing QoS on the edge of a tactical data network. Additionally, there is a need for systems and methods for a protocol transformation gateway for QoS.

### BRIEF SUMMARY OF THE INVENTION

Embodiments of the present invention provide systems and methods for facilitating communication of data. A method includes providing quality of service in a network including receiving data, prioritizing the data, transforming the data to generate transformed data, and communicating the transformed data. The data is received based at least in part on a first protocol. The data is prioritized to support a quality of service standard. The transformed data is based at least in part on a second protocol. The second protocol is different from the first protocol.

Certain embodiments provide a data communication system for providing content-based quality of service in a network including a reception component, a prioritization component, a transformation component, and a communication component. The reception component is adapted to receive a block of data based at least in part on a first protocol. The prioritization component is adapted to prioritize the block of data based at least in part on the content of the block of data and a rule. The transformation component is adapted to transform the block of data to generate a transformed block of data. The transformed block of data is based at least in part on a second protocol. The second protocol is different from the first protocol. The communication component is adapted to communicate the transformed block of data.

Certain embodiments provide a computer-readable medium including a set of instructions for execution on a computer, the set of instructions including a reception routine, a prioritization routine, a transformation routine, and a communication routine. The reception routine is configured to receive data. The data is received based at least in part on a first protocol. The prioritization routine is configured to prioritize the data based at least in part on a rule. The transformation routine is configured to generate transformed data. The transformed data is based at least in part on a second protocol. The second protocol is different from the first protocol. The communication routine is configured to communicate the transformed data.

### BRIEF DESCRIPTION OF SEVERAL VIEWS OF THE DRAWINGS

FIG. 1 illustrates a tactical communications network environment operating with an embodiment of the present invention.

FIG. 2 shows the positioning of the data communications system in the seven layer OSI network model in accordance with an embodiment of the present invention.

FIG. 3 depicts an example of multiple networks facilitated using the data communications system in accordance with an embodiment of the present invention.

FIG. 4 illustrates a data communication environment operating with an embodiment of the present invention.

FIG. 5 illustrates an embodiment of a data communication system according to an embodiment of the present invention.

FIG. 6 illustrates a flow diagram for a method for communicating data in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

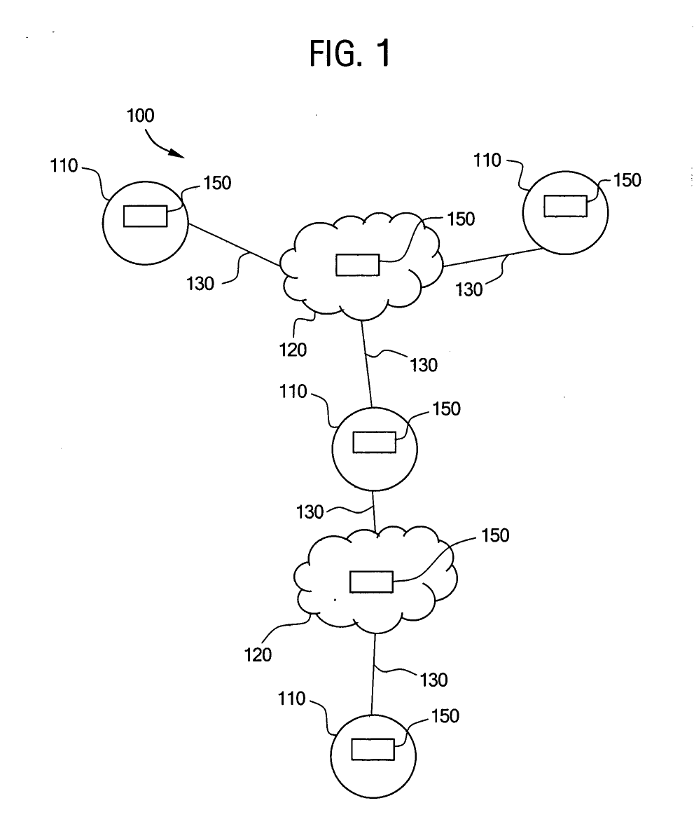

FIG. 1 illustrates a tactical communications network environment 100 operating with an embodiment of the present invention. The network environment 100 includes a plurality of communication nodes 110, one or more networks 120, one or more links 130 connecting the nodes and network(s), and one or more communication systems 150 facilitating communication over the components of the network environment 100. The following discussion assumes a network environment 100 including more than one network 120 and more than one link 130, but it should be understood that other environments are possible and anticipated.

Communication nodes 110 may be and/or include radios, transmitters, satellites, receivers, workstations, servers, and/or other computing or processing devices, for example.

Network(s) 120 may be hardware and/or software for transmitting data between nodes 110, for example. Network(s) 120 may include one or more nodes 110, for example. Link(s) 130 may be wired and/or wireless connections to allow transmissions between nodes 110 and/or network(s) 120.

The communications system 150 may include software, firmware, and/or hardware used to facilitate data transmission among the nodes 110, networks 120, and links 130, for example. As illustrated in FIG. 1, communications system 150 may be implemented with respect to the nodes 110, network(s) 120, and/or links 130. In certain embodiments, every node 110 includes a communications system 150. In certain embodiments, one or more nodes 110 include a communications system 150. In certain embodiments, one or more nodes 110 may not include a communications system 150.

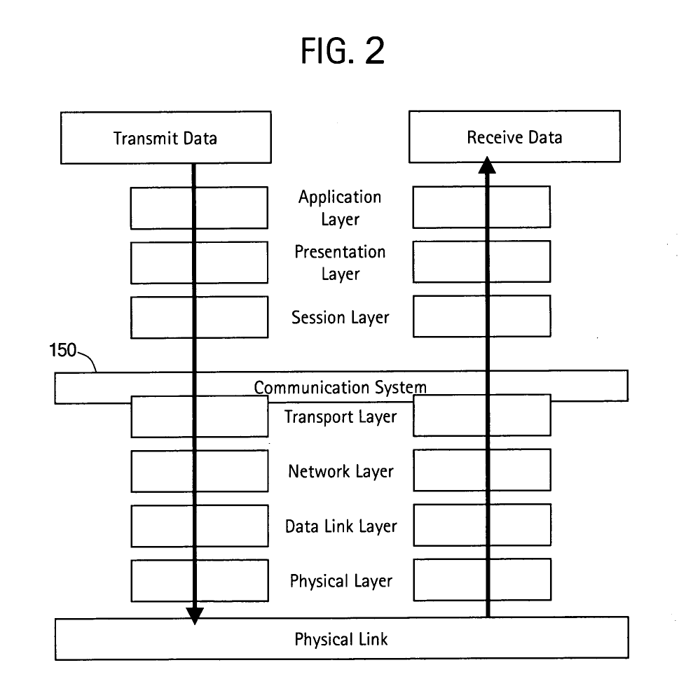

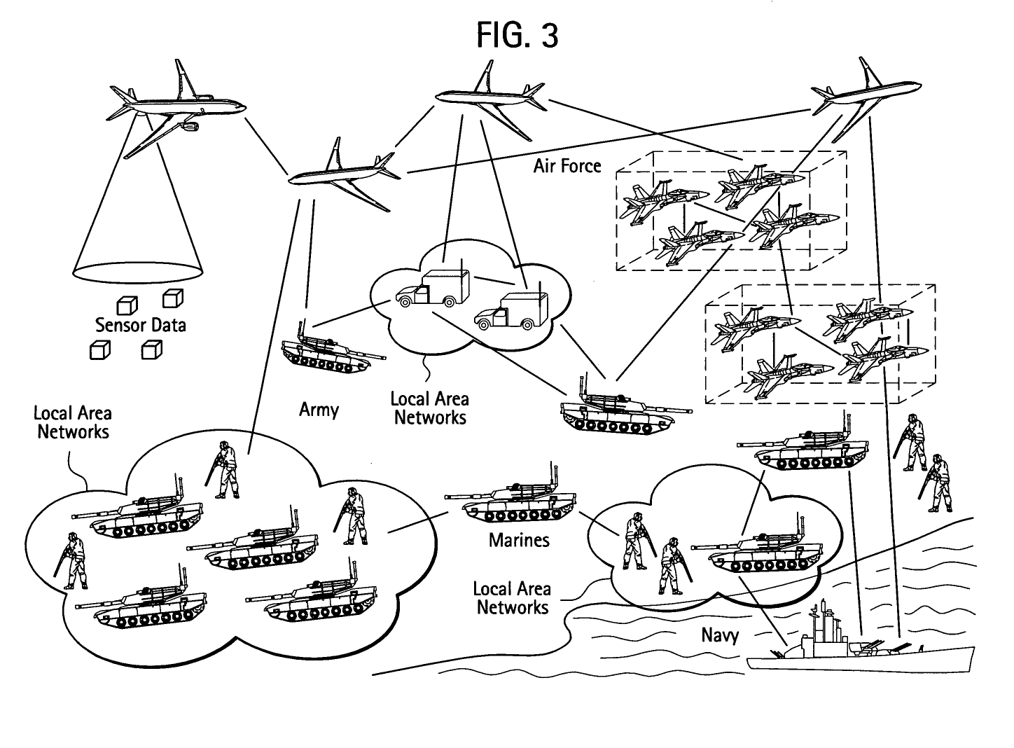

The communication system 150 provides dynamic management of data to help assure communications on a tactical communications network, such as the network environment 100. As shown in FIG. 2, in certain embodiments, the system 150 operates as part of and/or at the top of the transport layer in the OSI seven layer protocol model. The system 150 may give precedence to higher priority data in the tactical network passed to the transport layer, for example. The system 150 may be used to facilitate communications in a single network, such as a local area network (LAN) or wide area network (WAN), or across multiple networks. An example of a multiple network system is shown in FIG. 3. The system 150 may be used to manage available bandwidth rather than add additional bandwidth to the network, for example.

In certain embodiments, the system 150 is a software system, although the system 150 may include both hardware and software components in various embodiments. The system 150 may be network hardware independent, for example. That is, the system 150 may be adapted to function on a variety of hardware and software platforms. In certain embodiments, the system 150 operates on the edge of the network rather than on nodes in the interior of the network. However, the system 150 may operate in the interior of the network as well, such as at “choke points” in the network.

The system 150 may use rules and modes or profiles to perform throughput management functions such as optimizing available bandwidth, setting information priority, and managing data links in the network. By “optimizing” bandwidth, it is meant that the presently described technology can be employed to increase an efficiency of bandwidth use to communicate data in one or more networks. Optimizing bandwidth usage may include removing functionally redundant messages, message stream management or sequencing, and message compression, for example. Setting information priority may include differentiating message types at a finer granularity than Internet Protocol (IP) based techniques and sequencing messages onto a data stream via a selected rule-based sequencing algorithm, for example. Data link management may include rule-based analysis of network measurements to affect changes in rules, modes, and/or data transports, for example. A mode or profile may include a set of rules related to the operational needs for a particular network state of health or condition. The system 150 provides dynamic, “on-the-fly” reconfiguration of modes, including defining and switching to new modes on the fly.

The communication system 150 may be configured to accommodate changing priorities and grades of service, for example, in a volatile, bandwidth-limited network. The system 150 may be configured to manage information for improved data flow to help increase response capabilities in the network and reduce communications latency. Additionally, the system 150 may provide interoperability via a flexible architecture that is upgradeable and scalable to improve availability, survivability, and reliability of communications. The system 150 supports a data communications architecture that may be autonomously adaptable to dynamically changing environments while using predefined and predictable system resources and bandwidth, for example.

In certain embodiments, the system 150 provides throughput management to bandwidth-constrained tactical communications networks while remaining transparent to applications using the network. The system 150 provides throughput management across multiple users and environments at reduced complexity to the network. As mentioned above, in certain embodiments, the system 150 runs on a host node in and/or at the top of layer four (the transport layer) of the OSI seven layer model and does not require specialized network hardware. The system 150 may operate transparently to the layer four interface. That is, an application may utilize a standard interface for the transport layer and be unaware of the operation of the system 150. For example, when an application opens a socket, the system 150 may filter data at this point in the protocol stack. The system 150 achieves transparency by allowing applications to use, for example, the TCP/IP socket interface that is provided by an operating system at a communication device on the network rather than an interface specific to the system 150. System 150 rules may be written in extensible markup language (XML) and/or provided via custom dynamic link libraries (DLLs), for example.

In certain embodiments, the system 150 provides quality of service (QoS) on the edge of the network. The system's QoS capability offers content-based, rule-based data prioritization on the edge of the network, for example. Prioritization may include differentiation and/or sequencing, for example. The system 150 may differentiate messages into queues based on user-configurable differentiation rules, for example. The messages are sequenced into a data stream in an order dictated by the user-configured sequencing rule (e.g., starvation, round robin, relative frequency, etc.). Using QoS on the edge, data messages that are indistinguishable by traditional QoS approaches may be differentiated based on message content, for example. Rules may be implemented in XML, for example. In certain embodiments, to accommodate capabilities beyond XML and/or to support extremely low latency requirements, the system 150 allows dynamic link libraries to be provided with custom code, for example.

Inbound and/or outbound data on the network may be customized via the system 150. Prioritization protects client applications from high-volume, low-priority data, for example. The system 150 helps to ensure that applications receive data to support a particular operational scenario or constraint.

In certain embodiments, when a host is connected to a LAN that includes a router as an interface to a bandwidth-constrained tactical network, the system may operate in a configuration known as QoS by proxy. In this configuration, packets that are bound for the local LAN bypass the system and immediately go to the LAN. The system applies QoS on the edge of the network to packets bound for the bandwidth-constrained tactical link.

In certain embodiments, the system 150 offers dynamic support for multiple operational scenarios and/or network environments via commanded profile switching. A profile may include a name or other identifier that allows the user or system to change to the named profile. A profile may also include one or more identifiers, such as a functional redundancy rule identifier, a differentiation rule identifier, an archival interface identifier, a sequencing rule identifier, a pre-transmit interface identifier, a post-transmit interface identifier, a transport identifier, and/or other identifier, for example. A functional redundancy rule identifier specifies a rule that detects functional redundancy, such as from stale data or substantially similar data, for example. A differentiation rule identifier specifies a rule that differentiates messages into queues for processing, for example. An archival interface identifier specifies an interface to an archival system, for example. A sequencing rule identifier identifies a sequencing algorithm that controls samples of queue fronts and, therefore, the sequencing of the data on the data stream. A pre-transmit interface identifier specifies the interface for pre-transmit processing, which provides for special processing such as encryption and compression, for example. A post-transmit interface identifier identifies an interface for post-transmit processing, which provides for processing such as de-encryption and decompression, for example. A transport identifier specifies a network interface for the selected transport.

A profile may also include other information, such as queue sizing information, for example. Queue sizing information identifiers a number of queues and amount of memory and secondary storage dedicated to each queue, for example.

In certain embodiments, the system 150 provides a rules-based approach for optimizing bandwidth. For example, the system 150 may employ queue selection rules to differentiate messages into message queues so that messages may be assigned a priority and an appropriate relative frequency on the data stream. The system 150 may use functional redundancy rules to manage functionally redundant messages. A message is functionally redundant if it is not different enough (as defined by the rule) from a previous message that has not yet been sent on the network, for example. That is, if a new message is provided that is not sufficiently different from an older message that has already been scheduled to be sent, but has not yet been sent, the newer message may be dropped, since the older message will carry functionally equivalent information and is further ahead in the queue. In addition, functional redundancy many include actual duplicate messages and newer messages that arrive before an older message has been sent. For example, a node may receive identical copies of a particular message due to characteristics of the underlying network, such as a message that was sent by two different paths for fault tolerance reasons. As another example, a new message may contain data that supersedes an older message that has not yet been sent. In this situation, the system 150 may drop the older message and send only the new message. The system 150 may also include priority sequencing rules to determine a priority-based message sequence of the data stream. Additionally, the system 150 may include transmission processing rules to provide pre-transmission and post-transmission special processing, such as compression and/or encryption.

In certain embodiments, the system 150 provides fault tolerance capability to help protect data integrity and reliability. For example, the system 150 may use user-defined queue selection rules to differentiate messages into queues. The queues are sized according to a user-defined configuration, for example. The configuration specifies a maximum amount of memory a queue may consume, for example. Additionally, the configuration may allow the user to specify a location and amount of secondary storage that may be used for queue overflow. After the memory in the queues is filled, messages may be queued in secondary storage. When the secondary storage is also full, the system 150 may remove the oldest message in the queue, logs an error message, and queues the newest message. If archiving is enabled for the operational mode, then the de-queued message may be archived with an indicator that the message was not sent on the network. Memory and secondary storage for queues in the system 150 may be configured on a per-link basis for a specific application, for example. A longer time between periods of network availability may correspond to more memory and secondary storage to support network outages. The system 150 may be integrated with network modeling and simulation applications, for example, to help identify sizing to help ensure that queues are sized appropriately and time between outages is sufficient to help achieve steady-state and help avoid eventual queue overflow.

Furthermore, in certain embodiments, the system 150 offers the capability to meter inbound (“shaping”) and outbound (“policing”) data. Policing and shaping capabilities help address mismatches in timing in the network. Shaping helps to prevent network buffers form flooding with high-priority data queued up behind lower-priority data. Policing helps to prevent application data consumers from being overrun by low-priority data. Policing and shaping are governed by two parameters: effective link speed and link proportion. The system 150 may form a data stream that is no more than the effective link speed multiplied by the link proportion, for example. The parameters may be modified dynamically as the network changes. The system may also provide access to detected link speed to support application level decisions on data metering. Information provided by the system 150 may be combined with other network operations information to help decide what link speed is appropriate for a given network scenario.

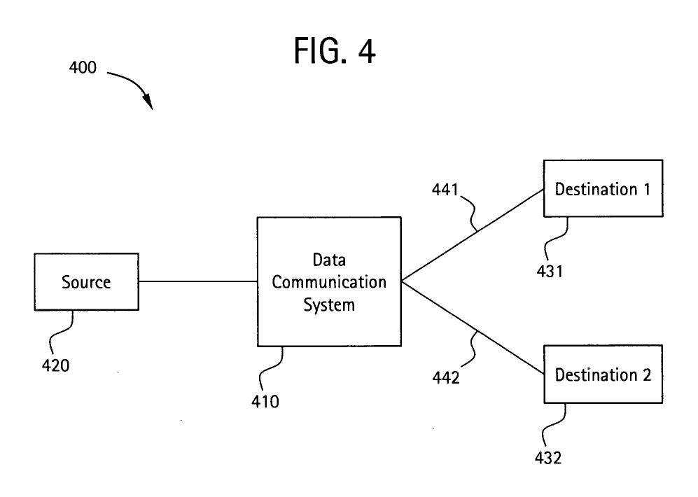

FIG. 4 illustrates a data communication environment 400 operating with an embodiment of the present invention. The environment 400 includes a data communication system 410, a source node 420, a first destination node 431, and a second destination node 432.

The data communication system 410 is in communication with the source node 420. The data communication system 410 may communicate with the source node 420 over a link such as a high speed LAN, through inter-process communication, or using an application programming interface (API) such as sockets, for example. For example, the source node 420 may be part of the same computing system as the data communication system 410.

The data communication system 410 is in communication with the first destination node 431. The data communication system 410 may communicate with the first destination node 431 over a first link 441. The first link 441 may be a direct link to the first destination node 431, for example. Alternatively, the first link 441 may be part of a network over which the data communication system 410 may communicate with the first destination node 431. The first link 441 may be part of a high speed LAN, for example. Alternatively, the first link 441 may include inter-process communication or API such as sockets. For example, the source node 420 may be part of the same computing system as the data communication system 410. In certain embodiments, the first link 441 is not part of a tactical data network. In certain embodiments, the first destination node 431 is on the same network as the source node 420. In certain embodiments, the first destination node 431 is on the same computing system as the source node 420.

The data communication system 410 is in communication with the second destination node 432. The data communication system 410 may communicate with the second destination node 432 over a second link 442. The second link 442 may be a direct link to the second destination node 432, for example. Alternatively, the second link 442 may be part of a network over which the data communication system 410 may communicate with the second destination node 432. The second link 442 may be a radio or satellite link, for example. In certain embodiments, the second link 442 is part of a tactical data network. In certain embodiments, the second link 442 is bandwidth constrained. In certain embodiments, the second link 442 is unreliable and/or intermittently disconnected. In certain embodiments, the second link 442 is a different link from the first link 441. In certain embodiments, the second link 442 is part of a different network than the first link 441.

The source node 420 communicates data to the data communication system 410. The source node 420 may include, for example, an application. The source node 420 may communicate with the data communication system 410 over a link, as discussed above. For example, the source node 420 may communicate with the data communication system 410 over a high speed LAN.

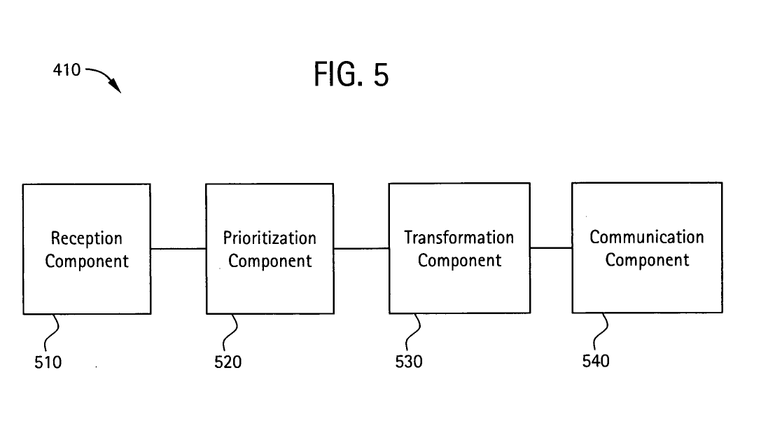

The data communication system 410 may be similar to the communication system 150, described above, for example. FIG. 5 illustrates an embodiment of the data communication system 410 according to an embodiment of the present invention. The embodiment of the data communication system 410 illustrated in FIG. 5 includes a reception component 510, a prioritization component 520, a transformation component 530, and a communication component 540. The reception component 510 is in communication with the prioritization component 520. The prioritization component 520 is in communication with the transformation component 530. The transformation component 530 is in communication with the communication component 540. In certain embodiments, the prioritization component 520 is in communication with the communication component 540.

In certain embodiments, the data communication system 410 is adapted to receive data from the source node 420. The data may be received by reception component 510, for example. The reception component 510 is adapted to receive data. In certain embodiments, the reception component 510 is adapted to receive data based at least in part on a protocol.

In certain embodiments, the data communication system 410 may include one or more queues for storing, organizing, and/or prioritizing the data. Alternatively, other data structures may be used for storing, organizing, and/or prioritizing the data. For example, a table, tree, or linked list may be used. The queues or other data structures may be provided by the prioritization component 520, for example. The prioritization component 520 is adapted to prioritize data. The data may be received from the reception component 510, for example.

In certain embodiments, the data communication system 410 is adapted to transform the data from using one protocol to using a second protocol. The data may be transformed by the transformation component 530, for example. The transformation component 530 is adapted to transform data to generate transformed data. The data to be transformed may be received from the reception component 510, for example. The data to be transformed may be received from the prioritization component 520, for example. The transformation component 530 is adapted to transform data received using a first protocol into transformed data using a second protocol.

In certain embodiments, the data communication system 410 is adapted to communicate data to the first destination node 431. In certain embodiments, the data communication system 410 is adapted to communicate data to the second destination node 432. The data may be communicated by the communication component 540, for example. The communications component 540 is adapted to communicate data. The data may be the data received by the reception component 510, for example. The data may be the data prioritized by the prioritization component 520, for example. The data may be the data transformed by the transformation component 530, for example. The data may be the transformed data generated by the transformation component 530, for example.

The first destination node 431 receives data from the data communication system 410. The first destination node 431 may include, for example, an application. The first destination node 431 may communicate with the data communication system 410 over a link, such as link 441, as discussed above.

In certain embodiments, the first destination node 431 and the data communication system 410 are part of the same computer system. For example, the first destination node 431 may be an application running on the same computer system as the data communication system 410. This embodiment may be similar to the embodiment discussed above wherein the source node 420 is part of the same computer system as the data communication system 410.

The second destination node 432 receives data from the data communication system 410. The second destination node 432 may include, for example, an application, radio, or satellite. The second destination node 432 may communicate with the data communication system 410 over a link, such as link 442, as discussed above.

The data received, stored, prioritized, processed, communicated, and/or transmitted by data communication system 410, the source node 420, the first destination node 431, and/or the second destination node 432 may include a block of data. The block of data may be, for example, a packet, cell, frame, and/or stream. For example, the data communication system 410 may receive packets of data from the source node 420. As another example, the data communication system 410 may process a stream of data from the source node 420.

In operation, the source node 420 provides and/or generates, at least in part, data handled by the data communication system 410. The source node 420 may include, for example, an application. The source node 420 may communicate with the data communication system 410 over a link, as discussed above. For example, the source node 420 may communicate with the data communication system 410 over a high speed LAN. The source node 420 may generate a continuous stream of data or may burst data, for example. As discussed above, the data may be a block of data, for example.

The data may be communicated using one or more protocols. For example, the source node 420 may communicate the data using a network layer and a transport layer protocol. Data may be received at the data communication system 410 over one or more protocols such as data link layer, network layer, and/or transport layer protocols. For example, the protocol may be and/or include a transport protocol such as Transmission Control Protocol (TCP), User Datagram Protocol (UDP), or Stream Control Transmission Protocol (SCTP). As another example, the protocol may be and/or include Internet Protocol (IP), Internetwork Packet Exchange (IPX), Ethernet, Asynchronous Transfer Mode (ATM), File Transfer Protocol (FTP), and/or Real-time Transport Protocol (RTP).

In certain embodiments, the source node 420 and the data communication system 410 are part of the same computer system. For example, the source node 420 may be an application running on the same computer system as the data communication system 410. The application may communicate data to the data communication system 410 over a protocol defined by, for example, inter-process communication or a transport layer interface such as sockets. That is, the data may be communicated using a protocol conforming to an API such as sockets. From the perspective of the application, the application may be unaware data is being passed to the data communication system 410 via the interface. Thus, in certain embodiments, the data communication system 410 may act as and/or be viewed by the source node 420 as a driver of the computing system, for example.

Data is received by the data communication system 410. The data may be received by a reception component, for example. The reception component may be similar to the reception component 510, for example. As discussed above, the data may be communicated using and/or according to at least one protocol. For example, the data may be over a one or more protocols such as data link layer, network layer, and/or transport layer protocols. In certain embodiments, the data is received from the source node 420. For example, as discussed above, the source node 420 may generate the data and communicate it to the data communication system 410 using a protocol. In certain embodiments, the data is received from the first destination node 431. For example, the first destination node 431 may respond to a message sent from the source node 420. In certain embodiments, the data is received from the second destination node 432. For example, the second destination node 432 may respond to a message from the source node 420 over the second link 442. Thus, in certain embodiments, the data communication system 410 may act as a gateway, forwarder, and/or proxy from the perspective of the source node 420 with respect to the first destination node 431 and/or the second destination node 432.

In certain embodiments, the data communication system 410 may not receive all of the data. For example, some of the data may be stored in a buffer and the data communication system 410 may receive only header information and a pointer to the buffer. For example, the data communication system 410 may be hooked into the protocol stack of an operating system and when an application passes data to the operating system through a transport layer interface (e.g., sockets), the operating system may then provide access to the data to the data communication system 410.

In certain embodiments, the data communication system 410 may organize and/or prioritize the data. In certain embodiments, the data communication system 410 may determine a priority for a block of data. For example, when a block of data is received by the data communication system 410, a prioritization component of the data communication system 410 may determine a priority for that block of data. As another example, a block of data may be stored in a queue in the data communication system 410 and a prioritization component may extract the block of data from the queue based on a priority determined for the block of data and/or for the queue. The prioritization component may be similar to the prioritization component 520, for example.

The prioritization of the data by the data communication system 410 may be used to provide and/or support QoS, for example. For example, the data communication system 410 may determine a priority for data received over a tactical data network. The priority may be based on the content of the data, for example. For example, data from a general with orders for units in the field may be given higher priority than a chat session between two soldiers not on patrol. The priority may be used to determine which of a plurality of queues the data should be placed into for subsequent communication by the data communication system 410. For example, higher priority data may be placed in a queue intended to hold higher priority data, and in turn, the data communication system 410, in determining what data to next communicate may look first to the higher priority queue.

The data may be prioritized based at least in part on one or more rules. As discussed above, the rules may be user defined. In certain embodiments, rules may be written in XML and/or provided via custom DLLs, for example. A rule may specify, for example, that data received from one application or node be favored over data from another application or node.

In certain embodiments, the data communication system 410 does not drop data. That is, although data may be low priority, it is not dropped by the data communication system 410. Rather, the data may be delayed for a period of time, potentially dependent on the amount of higher priority data that is received.

Data is communicated from the data communication system 410. In certain embodiments, a communication component is used to communicate the data. The communication component may be similar to the communication component 540, for example. The data may be communicated to the first destination node 431 and/or the second destination node 432, for example. As discussed above, the data may be communicated over the first link 441 and/or the second link 442, for example.

In certain embodiments, when data is to be communicated to a node that is not over a tactical data network, the data may be communicated by the data communication system 410 according to the protocol the data was received using. For example, when data is intended to be communicated to the first destination node 431, the data communication system 410 communicates data over the first link 441. In certain embodiments, the data communication system 410 communicates the data in the same protocol as that in which the data was received. In certain embodiments, the data communication system 410 communicates with the first destination node 431 using inter-process communication.

In certain embodiments, when data is to be communicated to a node over a tactical data network, the data communication system 410 may transform the data. For example, when data is intended to be communicated to the second destination node 432, the data communication system 410 may transform the data. In certain embodiments, the data may be transformed at least in part by a transformation component. The transformation component may be similar to the transformation component 530, for example. In certain embodiments, the transformation component 530 is adapted to generated transformed data. The transformed data may be based at least in part on the received data, for example.

The transformation may include transforming data from one protocol to another. For example, a header for the transport, network, and/or data link layer protocol that the data was received using may be removed and/or altered to conform to another transport, network, and/or data link layer protocol. As another example, data received over TCP may be transformed to be communicated using UDP. As another example, data received from the second destination node 432 over a tactical data network using UDP may be transformed to be communicated to the source node 420 over a high speed LAN using TCP. As another example, the transformation of the data may include reformatting and/or restructuring the data from a format used by a first protocol to the format used by a second protocol.

In certain embodiments, the transformation of the data occurs at least in part before the data is prioritized and at least in part after the data is prioritized. For example, header information from the transport protocol the data was received over may be removed before prioritization. Header information for a different transport protocol may then be added to the data to complete the transformation after prioritization.

In certain embodiments, the data communication system 410 includes a subscription. The subscription may be a rule or entry in a table, for example. The data communication system 410 may receive data based at least in part on the subscription. The subscription may include one or more of a source address, a destination address, a source port, a destination port, and/or a protocol type, for example. For example, the subscription may specify that the data communication system 410 should receive data from the source node 420 by indicating that TCP data should be received from the IP address of the source node 420. In certain embodiments, the subscription is defined at least in part by a user.

In certain embodiments, the data communication system 410 includes a publication. The publication may be a rule or entry in a table, for example. The data communication system 410 may transmit data based at least in part on the publication. The publication may include one or more of a source address, a destination address, a source port, a destination port, and/or a protocol type, for example. For example, the publication may specify that the data communication system 410 should transmit data to the second destination node 432 by indicating that UDP data should be sent to the IP address of the second destination node 432. In certain embodiments, the publication is defined at least in part by a user.

In certain embodiments, a subscription is associated with a publication. That is, a particular subscription similar to the subscription described above, is associated with a particular publication similar to the publication described above. For example, a subscription may specify that TCP data with a source IP address of the source node 420 is to be received by the data communication system 410 and that the data communication system 410 is to transmit that data to the destination IP address of the second destination node 432 using the UDP transport protocol.

In certain embodiments, the transformation of the data occurs at least in part in the protocol stack of the operating system. For example, the data communication system 410 may read data from a TCP socket, prioritize the data, and then based at least in part on a publication and subscription association, write the data to a UDP socket. The transformation of the data begins with the reception and reading of the data from the TCP socket and is completed with the writing and transmitting of the data with the UDP socket.

In certain embodiments, the data communication system 410 includes a mode or profile indicator. The mode indicator may represent the current mode or state of the data communication system 410, for example. As discussed above, the data communications system 410 may use rules, publications, subscriptions, and modes or profiles to perform throughput management functions such as optimizing available bandwidth, setting information priority, and managing data links in the network. The different modes may affecting changes in rules, publications, subscriptions, modes, and/or data transports, for example. A mode or profile may include a set of rules, publications and/or subscriptions related to the operational needs for a particular network state of health or condition. The data communication system 410 may provide dynamic reconfiguration of modes, including defining and switching to new modes “on-the-fly,” for example.

In certain embodiments, the data communication system 410 is transparent to other applications. For example, the processing, organizing, and/or prioritization performed by the data communication system 410 may be transparent to the source node 420 or other applications or data sources. For example, an application running on the same system as data communication system 410, or on the source node 420 connected to the data communication system 410, may be unaware of the prioritization of data performed by the data communication system 410.

As discussed above, the components, elements, and/or functionality of the data communication system 410 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

In one embodiment, for example, a command center such as a Tactical Operations Center (TOC) includes a high speed LAN and a gateway server including the data communication system 410, described above. The data communication system 410 may facilitate communication with QoS between nodes on networks connected to the gateway server.

The command center's LAN connects nodes such as workstations, servers, and video conferencing stations. The nodes may run legacy and/or COTS applications, for example. The nodes may communicate with one another using the transport layer protocol TCP, for example. TCP works well on high speed LANs. The gateway server connects the command center LAN with other high speed networks and one or more tactical data networks. For example, the gateway server may be connected to another LAN in another part of the command center and may route data between the two LANs. Nodes on the two LANs may communicate with each other using TCP. For example, commanders in two different parts of the command center may video conference over the two LANs. As another example, data generated by a logistics commander may be communicated to a traffic control commander in another part of the TOC using TCP over the two LANs.

The gateway server is also connected to a tactical data network. For example, the gateway server may connect the command center LAN with a node such as a radio, satellite, or aircraft over a tactical data network. For example, a commander in the command center may issue orders a unit in the field using an application running on a node on the command center LAN that communicates through the gateway server over a tactical data network to the radio with the unit in the field. However, the application used by the commander to issue the orders may be designed to use TCP to communicate. As mentioned above, TCP may not function well, if at all, over a tactical data network. Thus, the data communication system 410 may transparently transform the TCP data to use another protocol such as UDP to communicate the data to the unit in the field.

Communication may occur through the gateway server in the other direction as well. For example, an aircraft may communicate using a satellite radio over a tactical data network through the gateway server to an application running on a computer on the command center LAN. The data may be communicated from the aircraft using a protocol including the UDP transport layer protocol. The gateway server may then transform the data and communicate the transformed data to an application running on a node in the command center over a protocol including TCP.

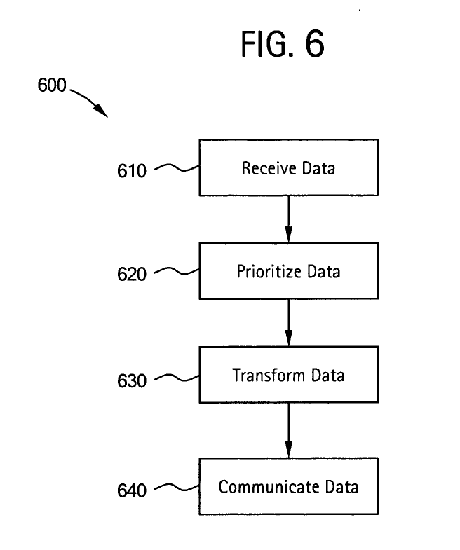

FIG. 6 illustrates a flow diagram for a method 600 for communicating data in accordance with an embodiment of the present invention. The method 600 includes the following steps, which will be described below in more detail. At step 610, data is received. At step 620, data is prioritized. At step 630, data is transformed. At step 640, data is communicated. The method 600 is described with reference to elements of systems described above, but it should be understood that other implementations are possible.

At step 610, data is received. Data may be received at the data communication system 410, for example. The data may be received by a reception component, for example. The reception component may be similar to the reception component 510, for example. The data may be received over one or more links, for example. The data may be provided and/or generated by the source node 420, for example. For example, data may be received at the data communication system 410 from a workstation in a command center over a high speed LAN. As another example, data may be provided to the data communication system 410 by an application running on the same system by an inter-process communication mechanism. As discussed above, the data may be a block of data, for example. In certain embodiments, the data is received over a tactical data network. For example, the data may be received from the second destination node 432. The data may be received over the second link 442, for example. As another example, the data may be received over a satellite radio from a unit in the field.

In certain embodiments, the data communication system 410 may not receive all of the data. For example, some of the data may be stored in a buffer and the data communication system 410 may receive only header information and a pointer to the buffer. For example, the data communication system 410 may be hooked into the protocol stack of an operating system, and, when an application passes data to the operating system through a transport layer interface (e.g., sockets), the operating system may then provide access to the data to the data communication system 410.

At step 620, data is prioritized. The data may be prioritized and/or organized by data communication system 410, for example. The data may be prioritized by a prioritization component, for example. The prioritization component may be similar to the prioritization component 520, for example. The data to be prioritized may be the data that is received at step 610, for example. In certain embodiments, the data communication system 410 may determine a priority for a block of data. For example, when a block of data is received by the data communication system 410, a prioritization component of the data communication system 410 may determine a priority for that block of data. As another example, a block of data may be stored in a queue in the data communication system 410 and the prioritization component 520 may extract the block of data from the queue based on a priority determined for the block of data and/or for the queue.

The prioritization of the data may be used to provide and/or support QoS, for example. For example, the data communication system 410 may determine a priority for a data received over a tactical data network. The priority may be based on the content of the data, for example. For example, data from a general with orders for units in the field may be given higher priority than a chat session between two soldiers not on patrol. The priority may be used to determine which of a plurality of queues the data should be placed into for subsequent communication by the data communication system 410. For example, higher priority data may be placed in a queue intended to hold higher priority data, and in turn, the data communication system 410, in determining what data to next communicate may look first to the higher priority queue.

The data may be prioritized based at least in part on one or more rules. As discussed above, the rules may be user defined and/or programmed based on system and/or operational constraints, for example. In certain embodiments, rules may be written in XML and/or provided via custom DLLs, for example. A rule may specify, for example, that data received from one application or node be favored over data from another application or node.

In certain embodiments, the data to be prioritized is not dropped. That is, although data may be low priority, it is not dropped by the data communication system 410. Rather, the data may be delayed for a period of time, potentially dependent on the amount of higher priority data that is received.

At step 630, data is transformed. The data may be transformed by the data communication system 410, for example. The data may be transformed by a transformation component, for example. The transformation component may be similar to the transformation component 530, for example. The data may be the data received at step 610, for example. The data may be the data prioritized at step 620, for example.

The transformation may include transforming data from one protocol to another. For example, a header for the transport, network, and/or data link layer protocol that the data was received using may be removed and/or altered to conform to another transport, network, and/or data link layer protocol. As another example, data received over TCP may be transformed to be communicated using UDP. As another example, data received from the second destination node 432 over a tactical data network using UDP may be transformed to be communicated to the source node 420 over a high speed LAN using TCP. As another example, the transformation of the data may include reformatting and/or restructuring the data from a format used by a first protocol to the format used by a second protocol.

In certain embodiments, the transformation of the data occurs at least in part before the data is prioritized and at least in part after the data is prioritized at step 620. For example, header information from the transport protocol the data was received over may be removed before the data is prioritized at step 620. Header information for a different transport protocol may then be added to the data to complete the transformation after the prioritization at step 620.

In certain embodiments, the transformation of the data occurs at least in part in the protocol stack of the operating system. For example, the data communication system 410 may read data from a TCP socket, prioritize the data, and then based at least in part on a publication and subscription association, write the data to a UDP socket. The transformation of the data begins with the reception and reading of the data from the TCP socket and is completed with the writing and transmitting of the data with the UDP socket.

At step 640, data is communicated. The data may be communicated by the data communication system 410, for example. The data may be communicated by a communication component, for example. The communication component may be similar to the communication component 540, for example. The data communicated may be the data received at step 610, for example. The data communicated may be the data prioritized at step 620, for example. The data communicated may be the data transformed at step 630, for example.

Data may be communicated from the data communication system 410, for example. The data may be communicated to the first destination node 431 and/or the second destination node 432, for example. The data may be communicated over one or more links, for example. For example, the data may be communicated over the first link 441 and/or the second link 442. As another example, the data may be communicated by the data communication system 410 over a tactical data network to a radio. As another example, data may be provided by the data communication system 410 to an application running on the same system by an inter-process communication mechanism and/or an API such as sockets.

In certain embodiments, the data may be received based at least in part on a subscription. The subscription may be similar to the subscription described above, for example. The subscription may include one or more of a source address, a destination address, a source port, a destination port, and/or a protocol type, for example. For example, the subscription may specify that the data communication system 410 should receive data from the source node 420 by indicating that TCP data should be received from the IP address of the source node 420. In certain embodiments, the subscription is defined at least in part by a user.

In certain embodiments, the data may be communicated based at least in part on a publication. The publication may be similar to the publication described above, for example. The publication may include one or more of a source address, a destination address, a source port, a destination port, and/or a protocol type, for example. For example, the publication may specify that the data communication system 410 should transmit data to the second destination node 432 by indicating that UDP data should be sent to the IP address of the second destination node 432. In certain embodiments, the publication is defined at least in part by a user.

In certain embodiments, a subscription is associated with a publication. That is, a particular subscription is associated with a particular publication. For example, a subscription may specify that TCP data with a source IP address of the source node 420 is to be received by the data communication system 410 and that the data communication system 410 is to transmit that data to the destination IP address of the second destination node 432 using the UDP transport protocol.

In certain embodiments, a mode or profile indicator may represent the current mode or state of the data communication system 410, for example. As discussed above, the rules, publications, subscriptions and modes or profiles may be used to perform throughput management functions such as optimizing available bandwidth, setting information priority, and managing data links in the network. The different modes may affecting changes in rules, publications, subscriptions, modes, and/or data transports, for example. A mode or profile may include a set of rules, publications, and/or subscriptions related to the operational needs for a particular network state of health or condition. The data communication system 410 may provide dynamic reconfiguration of modes, including defining and switching to new modes “on-the-fly,” for example.

In certain embodiments, the prioritization of data is transparent to other applications. For example, the processing, organizing, and/or prioritization performed by the data communication system 410 may be transparent to the source node 420 or other applications or data sources. For example, an application running on the same system as data communication system 410, or on the source node 420 connected to the data communication system 410, may be unaware of the prioritization of data performed by the data communication system 410.

One or more of the steps of the method 600 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide systems and methods for a protocol transformation gateway for QoS. In addition, certain embodiments allow data communicated in one protocol to be transformed to another protocol for communication to a node across a tactical data network. Further, certain embodiments allow dynamic protocol-switching based on operating conditions and system requirements. Certain embodiments provide a technical effect of a protocol transformation gateway for QoS. In addition, certain embodiments provide the technical effect of allowing data communicated in one protocol to be transformed to another protocol for communication to a node across a tactical data network. Further, certain embodiments provide the technical effect of allowing dynamic protocol-switching based on operating conditions and system requirements.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for providing quality of service in a network, the method including:
receiving data, wherein the data is received based at least in part on a first protocol;
prioritizing the data, wherein the data is prioritized to support a quality of service standard;
transforming the data to generate transformed data, wherein the transformed data is based at least in part on a second protocol, wherein the second protocol is different from the first protocol; and
communicating the transformed data.

2. The method of claim 1, wherein the received data is received over a tactical data network.

3. The method of claim 1, wherein the communicating step includes transmitting the transformed data over a tactical data network.

4. The method of claim 1, wherein at least one of the first protocol and the second protocol includes a protocol at the transport layer of a protocol stack.

5. The method of claim 1, wherein one of the first protocol and the second protocol is Transmission Control Protocol (TCP).

6. The method of claim 1, wherein one of the first protocol and the second protocol is User Datagram Protocol (UDP).

7. The method of claim 1, wherein the prioritizing step includes inserting the block of data in at least one of a plurality of queues based at least in part on the content of the data.

8. The method of claim 1, wherein the data is received based at least in part on a subscription, wherein the subscription includes an address and a protocol type.

9. The method of claim 8, wherein the subscription is user defined.

10. The method of claim 1, wherein the data is transformed based at least in part on a publication, wherein the publication includes an address and a protocol type.

11. The method of claim 10, wherein the publication is user defined.

12. The method of claim 1, wherein the received data is generated by an application, and wherein the transformation step is transparent to the application.

13. A data communication system for providing content-based quality of service in a network, the system including:
a reception component, wherein the reception component is adapted to receive a block of data based at least in part on a first protocol;
a prioritization component, wherein the prioritization component is adapted to prioritize the block of data based at least in part on the content of the block of data and a rule;
a transformation component, wherein the transformation component is adapted to transform the block of data to generate a transformed block of data, wherein the transformed block of data is based at least in part on a second protocol, wherein the second protocol is different from the first protocol; and
a communication component, wherein the communication component is adapted to communicate the transformed block of data.

14. The system of claim 13, wherein the block of data is received over a tactical data network, and wherein the transformed block of data is communicated over a network that is not a tactical data network.

15. The system of claim 13, wherein the block of data is received over a network that is not a tactical data network, and wherein the transformed block of data is communicated over a tactical data network.

16. The system of claim 13, wherein the block of data is received from an application program on the same node as the data communication system, and wherein the application uses a standard transport level interface to transparently communicate the block of data to the data communication system.

17. The system of claim 13, further including a mode indicator, wherein the block of data is transformed based at least in part on the mode indicator.

18. The system of claim 13, wherein the transformation component is adapted to generate the transformed block of data when the block of data has a destination on a tactical data network.

19. The system of claim 13, wherein the communication component is adapted to communicate the block of data based at least in part on the first protocol when the block of data has a destination that is not on a tactical data network.

20. A computer-readable medium including a set of instructions for execution on a computer, the set of instructions including:
a reception routine, wherein the reception routine is configured to receive data, wherein the data is received based at least in part on a first protocol;
a prioritization routine, wherein the prioritization routine is configured to prioritize the data based at least in part on a rule;
a transformation routine, wherein the transformation routine is configured to generate transformed data, wherein the transformed data is based at least in part on a second protocol, wherein the second protocol is different from the first protocol; and
a communication routine, wherein the communication routine is configured to communicate the transformed data.
